(19) United States
(12) Patent Application Publication
(10) Pub. No.: US 2021/0333078 A1
(43) Pub. Date: Oct. 28, 2021

(54) WIRELESS BLASTING SYSTEM AND OPERATING METHOD THEREOF

(71) Applicant: HANWHA CORPORATION, Seoul (KR)

(72) Inventors: Ki Won Hwang, Boeun-gun (KR); Yong Seok Kuk, Boeun-gun (KR); Ki Woong Park, Boeun-gun (KR)

(73) Assignee: HANWHA CORPORATION, Seoul (KR)

(21) Appl. No.: 16/627,637

(22) PCT Filed: Dec. 12, 2019
(86) PCT No.: PCT/KR2019/017631

§ 371 Date: Dec. 30, 2019

(30) Foreign Application Priority Data
Dec. 19, 2018 (KR) 10-2018-0165402

(51) Int. Cl. F42D 1/055; F42D 5/00; H04W 56/00

(52) U.S. Cl. CPC F42D 1/055; H04W 56/0055; F42D 5/00

(57) ABSTRACT

Provided is a method of operating a wireless blasting system in which a blasting device and electric detonators perform communications via a wireless network. Detonator reference times of the electric detonators are synchronized with a blasting reference time of the blasting device. Communication delay times of the electric detonators are calculated. The blasting device transmits a blasting command including a blasting time to the electric detonators. Whether or not the electric detonators are ready to perform blasting is determined by determining initial input states and detonator states of the electric detonators. When the electric detonators are ready, the electric detonators perform the blasting by counting ignition initialization times thereof in which the communication delay times are reflected.

### TECHNICAL FIELD

The present invention relates to a wireless blasting system and an operating method thereof and, more particularly, to a wireless blasting system and an operating method thereof, in which blasting can be performed accurately in consideration of communication delay times in the case of long-range wireless communications.

### BACKGROUND ART

In general, explosives are used in engineering work, such as in rock blasting, in the demolition of buildings, and open air blasting. That is, a plurality of holes, into which explosives are to be inserted, is drilled to correspond to the sections of a blasting target, i.e. the object to be blasted. After an explosive is inserted into each of the drilled holes, the explosives are connected to a blasting system. The explosives are ignited by operating the blasting system, thereby exploding the blasting target.

Such a blasting system includes a detonator serving as an igniter to ignite an explosive and a blasting device providing power necessary for the actuation of the detonator and a command signal to the detonator. Here, the detonator of the blasting system is generally implemented as an electric detonator. The electric detonator is disposed on an explosive side, and a plurality of detonators is connected to a single blasting device.

Such electric detonators may have a structure in which a plurality of detonators connected to a blasting device is simultaneously actuated to simultaneously detonate explosives, or a structure in which a plurality of detonators connected to a blasting device is set to have different delay times to be sequentially actuated to thus sequentially detonate explosives.

Blasting systems are categorized into a wireless blasting system and a wired blasting system depending on how the blasting device is connected to electric detonators.

Although electric detonators simultaneously detonating a plurality of explosives have been used to date, electric detonators sequentially detonating a plurality of explosives are more commonly used at present. For example, blasting systems using such an electric detonator are disclosed in a plurality of documents, such as Korean Patent No. 10-1016538, Korean Patent No. 10-0665878, Korean Patent No. 10-0665880, Korean Patent No. 10-0733346, and Japanese Patent Application Publication No. 2005-520115.

### DISCLOSURE

### Technical Problem

Accordingly, the present invention has been made keeping in mind the above problems occurring in the prior art, and an objective of the present invention is to provide a wireless blasting system and an operating method thereof, in which blasting can be performed accurately in consideration of communication delay times in the case of long-range wireless communications.

In addition, another objective of the present invention is to provide a wireless blasting system and an operating method thereof able to reduce working times and working costs.

In addition, another objective of the present invention is to provide a wireless blasting system and an operating method thereof applicable to massive mine blasting.

### Technical Solution

In order to accomplish the above objective, embodiments of the present invention provide a method of operating a wireless blasting system in which a blasting device and electric detonators perform communications via a wireless network. The method may include: synchronizing detonator reference times of the electric detonators with a blasting reference time of the blasting device; calculating communication delay times of the electric detonators; transmitting, by the blasting device, a blasting command including a blasting time to the electric detonators; determining whether or not the electric detonators are ready to perform blasting by determining initial input states and detonator states of the electric detonators; and when the electric detonators are ready, performing, by the electric detonators, the blasting by counting ignition initialization times thereof in which the communication delay times are reflected.

The synchronization may include: transmitting, by the blasting device, a synchronization request including the blasting reference time to the electric detonators; synchronizing, by the electric detonators, the detonator reference times with the blasting reference time by setting the detonator reference times to be the blasting reference time; and transmitting, by the electric detonators, synchronization complete signals to the blasting device.

The calculating of the communication delay times may include: performing, by the electric detonators and the blasting device, communications via the wireless network; calculating, by the blasting device, the communication delay times of the electric detonators; comparing, by the blasting device, values in which the communication delay times corresponding to the detonator reference times are reflected with the blasting reference time; and when a value among the values in which the communication delay times corresponding to the detonator reference times are reflected is equal to the blasting reference time, correcting a corresponding ignition initialization time among the ignition initialization times.

The transmitting of the blasting command may include: setting, by the blasting device, the blasting time on a basis of a maximum communication delay time and a state inspection time of the electric detonators; and transmitting, by the blasting device, the blasting command including the blasting time to the electric detonators.

The blasting device may set a sum of the maximum communication delay time and the state inspection time to be the blasting time.

The transmitting of the blasting command may include: calculating, by the electric detonators, estimated blasting times on a basis of the communication delay times; comparing, by the electric detonators, the estimated blasting times with the blasting time; when the blasting time is greater than an estimated blasting time among the estimated blasting times, transmitting, by a corresponding electric detonator among the electric detonators, an error signal to the blasting device; and resetting the electric detonator with the received blasting time and transmitting, by the electric detonator, a reset complete signal to the blasting device.

The method may further include, when the blasting time is not greater than an estimated blasting time among the estimated blasting times, transmitting, by a corresponding electric detonator among the electric detonators, a blasting acknowledgement to the blasting device.

The determining of whether or not the electric detonators are ready may include: transmitting, by the blasting device, a ready confirmation request to the electric detonators; determining, by the electric detonators, initial input states and detonator states in response to the ready confirmation request; when there is an error, transmitting, by an electric detonator among the electric detonators, a stop signal to the blasting device; and when there is no error, transmitting, by an electric detonator among the electric detonators, a preparation complete signal to the blasting device.

Each of the blasting device and the electric detonators may include a global positioning system device counting an absolute time.

The blasting device may be disposed in a safe area, the electric detonators are disposed in a blasting area spaced apart from the safe area by a safe distance, the safe distance may be a value predetermined by a blasting operator, and when the blasting device is located within the safe distance, the blasting may be stopped.

In order to accomplish the above objective, embodiments of the present invention provide a blasting system including: electric detonators disposed in blasting holes of a blasting target to detonate explosives; and a blasting device performing communications with the electric detonators via a wireless network. The blasting device may synchronize the detonator reference times of the electric detonators with the blasting reference time of the blasting device and calculates communication delay times of the electric detonators. Each of the blasting device and the electric detonators may include a global positioning system device.

The blasting device may be disposed in a safe area, the electric detonators are disposed in a blasting area spaced apart from the safe area by a safe distance, the safe distance may be a value predetermined by a blasting operator, and when the blasting device is located within the safe distance, the blasting may be stopped.

### Advantageous Effects

As described above, the wireless blasting system and the operating method thereof according to embodiments of the present invention can accurately activate blasting in consideration of communication delay times in the case of long-range wireless communications.

In addition, the wireless blasting system and the operating method thereof according to embodiments of the present invention can reduce working times and working costs.

Furthermore, the wireless blasting system and the operating method thereof according to embodiments of the present invention are applicable to massive mine blasting.

The advantages obtainable from the present invention are not limited to the aforementioned advantages, and other advantages not explicitly disclosed herein will be clearly understood by those skilled in the art to which the present invention pertains from the description provided hereinafter.

### DESCRIPTION OF DRAWINGS

FIG. 1 is a conceptual view illustrating a wireless blasting system according to an embodiment of the present invention;

FIG. 2 is a diagram illustrating the wireless blasting system according to an embodiment of the present invention;

FIG. 3 is a diagram illustrating the electric detonator according to an embodiment of the present invention;

FIG. 4 is a diagram illustrating the blasting device according to an embodiment of the present invention;

FIG. 5 is a flowchart illustrating a method of operating the wireless blasting system according to an embodiment of the present invention;

FIG. 6 is a diagram illustrating the synchronization step according to an embodiment of the present invention;

FIG. 7 is a flowchart illustrating the step of calculating the communication delay time according to an embodiment of the present invention;

FIG. 8 is a flowchart illustrating the step of transmitting the blasting command according to an embodiment of the present invention; and

FIG. 9 is a flowchart illustrating the step of determining whether or not blasting is ready to be performed according to an embodiment of the present invention.

### DESCRIPTION OF THE REFERENCE NUMERALS IN THE DRAWINGS

| | |
|---|---|
| 10: blasting system | 20: blasting target |
| 30: blasting hole | 40: explosive |
| 100: electric detonator | 200: blasting device |
| BZ: blasting area | SZ: safe area |

### BEST MODE

Hereinafter, embodiments of the present invention and matters necessary for those skilled in the art to readily understand the features of the present invention will be described in detail with reference to the accompanying drawings. These embodiments are only provided for illustrative purposes, since the present invention may be implemented in a variety of different forms without departing from the scope of the present invention defined by the claims.

In the drawings, the same components will be designated by the same reference numerals. In addition, the thicknesses, ratios, and sizes of the components may be exaggerated for effective descriptions of technical features. The expression “and/or” includes any one or any combination of the mentioned items.

Terms such as “first” and “second” may be used herein to describe a variety of elements, and the elements should not be limited by the terms. The terms are only used to distinguish one element from other elements. Thus, a first element may be referred to as a second element, and similarly, a second element may be referred to as a first element. Singular forms used herein are intended to mean “one or more” unless the context clearly indicates otherwise.

Terms, such as “below”, “beneath”, “under”, “lower”, “above”, and “upper”, may be used herein for ease of description of the relationship of an element to other elements as illustrated in the drawings. Such terms should be construed as describing relative relationships, and are used with respect to the orientations depicted in the drawings.

It will be further understood that the terms “comprise”, “include”, “have”, etc. when used in this specification, specify the presence of stated features, integers, steps, operations, components, parts, and/or combinations thereof, but do not preclude the presence or addition of one or more other features, integers, steps, operations, components, parts, and/or combinations thereof.

That is, the present disclosure is not limited to the embodiments disclosed below, and may be realized in various other forms. It will be understood that when an element is referred to as being “connected” to another element, not only can it be directly connected to the other element, but it can also be electrically connected to the other element via an intervening element. In designating elements of the drawings by reference numerals, the same elements will be designated by the same reference numerals even when they are shown in different drawings.

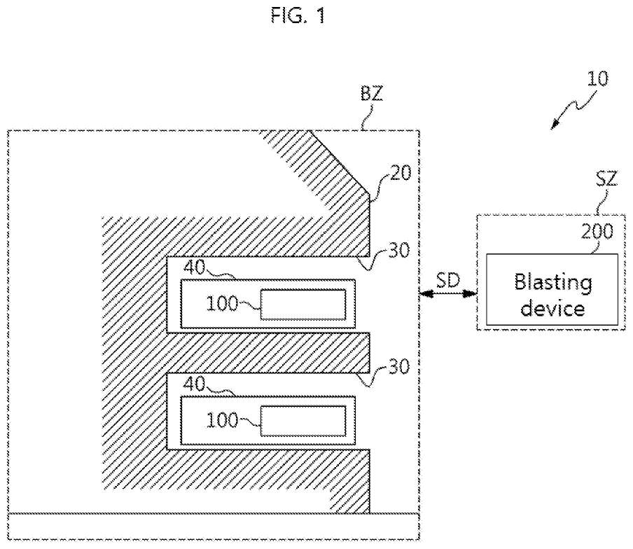

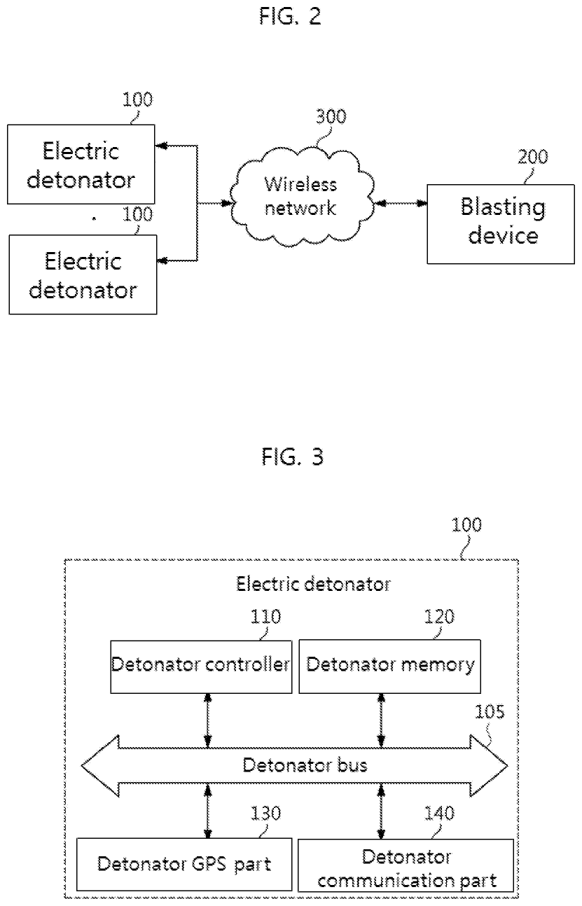

FIG. 1 is a conceptual view illustrating a wireless blasting system 10 according to an embodiment of the present invention. FIG. 2 is a diagram illustrating the wireless blasting system 10 according to an embodiment of the present invention.

Referring to FIGS. 1 and 2, the wireless blasting system 10 may include electric detonators 100 and a blasting device 200.

Blasting operators may form blasting holes 30 by drilling a blasting target 20 in order to explode the blasting target 20. Blasting operators may insert explosives 40 into the blasting holes 30, with the explosives 40 having the electric detonators 100 attached thereto, respectively.

A blasting operator may power on the electric detonators 100. When the electric detonators 100 are powered on, the electric detonators 100 may perform communications with the blasting device 200 via a wireless network 300. That is, the electric detonators 100 may be wirelessly connected to the blasting device 200 while repeatedly communicating with the blasting device 200. Here, the electric detonators 100 may be programmed in accordance with pre-designed values, and may transmit detonator information to the blasting device 200. For example, the detonator information may include a detonator identifier, position information, and the like.

The blasting device 200 may receive the detonator information from the electric detonators 100 via the wireless network 300 and store the received detonator information.

The electric detonators 100 may be located in a blasting zone BZ, and the blasting device 200 may be located in a safe zone SZ. The blasting zone BZ and the safe zone SZ may be spaced apart from each other by a safe distance SD. For example, the safe distance SD is a value predetermined by the blasting operator, and may be reset by the blasting operator. When the blasting device 200 is located within the safe distance SD, the wireless blasting system 10 may stop blasting. That is, when the distance between the blasting zone BZ and the safe zone SZ, in which the blasting device 200 is disposed, is smaller than the predetermined safe distance SD, the wireless blasting system 10 may stop blasting.

The blasting device 200 may be connected to the electric detonators 100 via the wireless network in order to perform wireless communications regarding the safe distance SD. For example, the wireless network may be implemented as any type of wireless network, such as a mobile radio communication network based on long-term evolution (LTE), a Bluetooth network, a Bluetooth low energy (BLE) network, a Zigbee® network, a Thread network, a Wi-Fi network, a wireless broadband (Wibro) network, and a long range (LoRa) network.

The operator may generate a blasting command by operating the blasting device 200 in order to start the blasting. The electric detonators 100 may receive the blasting command.

The blasting command may include an ignition initialization time for each of the electric detonators 100. The electric detonators 100 may start counting the ignition initialization time included in the blasting command. When the counting of a predetermined delay time is completed, the electric detonators 100 may detonate the explosives 40 connected thereto. Accordingly, the blasting device 200 may explode the blasting target 20 by detonating the plurality of explosives 40.

FIG. 3 is a diagram illustrating the electric detonator 100 according to an embodiment of the present invention.

Referring to FIG. 3, the electric detonator 100 may include a detonator bus 105, a detonator controller 110, a detonator memory 120, a detonator global positioning system (GPS) part 130, and a detonator communication part 140.

The detonator bus 105 may allow data to be transmitted among the detonator controller 110, the detonator memory 120, the detonator GPS part 130, and the detonator communication part 140. In some embodiments, the detonator bus 105 may be implemented as a bus interface.

The detonator controller 110 may control the overall operation of the electric detonator 100. In some embodiments, the detonator controller 110 may be implemented as a central processing unit (CPU), a microprocessor unit (MPU), a graphics processing unit (GPU), or the like.

The detonator memory 120 may store, therein, a plurality of commands of a program executable by the detonator controller 110, data regarding a list of parts, and data regarding characteristics of parts. In addition, the detonator memory 120 may store, therein, an ignition initialization time for the electric detonator 100. In some embodiments, the detonator memory 120 may be implemented as a read only memory (ROM), a random access memory (RAM), a hard disk drive (HDD), a solid state drive (SSD), or the like.

The detonator GPS part 130 may count an absolute time corresponding to the position (i.e. coordinates) of the respective electric detonator 100. That is, the detonator GPS part 130 may count the ignition initialization time for the electric detonator 100 on the basis of a detonator reference time (or absolute time). In some embodiments, the detonator GPS part 130 may include a GPS device able to accurately measure a point in time regarding a current position and count the absolute time by receiving signals transmitted by GPS satellites. Here, the detonator reference time may be a reference time of the GPS time system.

The detonator communication part 140 may perform communications with the blasting device 200 (see FIG. 1). For example, the detonator communication part 140 may perform communications with the blasting device 200 via the wireless network.

The detonator controller 110 may receive the blasting command via the detonator communication part 140. When the blasting command is received, the detonator controller 110 may count the ignition initialization time, included in the blasting command, via the detonator GPS part 130. When the counting of the ignition initialization time is completed, the detonator controller 110 may ignite the explosives 40 illustrated in FIG. 1.

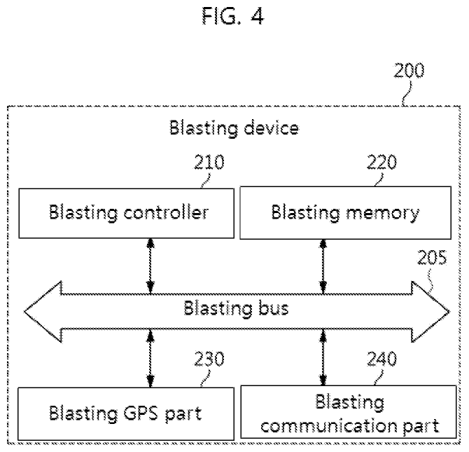

FIG. 4 is a diagram illustrating the blasting device 200 according to an embodiment of the present invention.

Referring to FIG. 4, the blasting device 200 may include a blasting bus 205, a blasting controller 210, a blasting memory 220, a blasting GPS part 230, and a blasting communication part 240.

The blasting bus 205 may perform data communications among the blasting controller 210, the blasting memory 220, the blasting GPS part 230, and the blasting communication part 240. In some embodiments, blasting bus 205 may be implemented as a bus interface.

The blasting controller 210 may control the overall operation of the blasting device 200. In some embodiments, the blasting controller 210 may be implemented as a central processing unit (CPU), a microprocessor unit (MPU), a graphics processing unit (GPU), or the like.

The blasting memory 220 may store, therein, a plurality of commands of a program executable by the blasting controller 210, data regarding a list of parts, and data regarding characteristics of parts. In addition, the blasting memory 220 may store an ignition initialization time therein. In some embodiments, the blasting memory 220 may be implemented as a read only memory (ROM), a random access memory (RAM), a hard disk drive (HDD), a solid state drive (SSD), or the like.

The blasting GPS part 230 may count an absolute time corresponding to the position (i.e. coordinates) of the blasting device 200. That is, the blasting GPS part 230 may set the ignition initialization times for the electric detonators 100 (see FIG. 1) on the basis of a blasting reference time (absolute time). In some embodiments, the blasting GPS part 230 may include a GPS device able to accurately measure a point in time regarding a current position and count the absolute time by receiving signals transmitted by GPS satellites. Here, the blasting reference time may be a reference time of the GPS time system.

The blasting communication part 240 may perform communications with the electric detonators 100. For example, the blasting communication part 240 may perform communications with the electric detonators 100 via the wireless network.

The blasting controller 210 may transmit the blasting command to the electric detonators 100 via the blasting communication part 240.

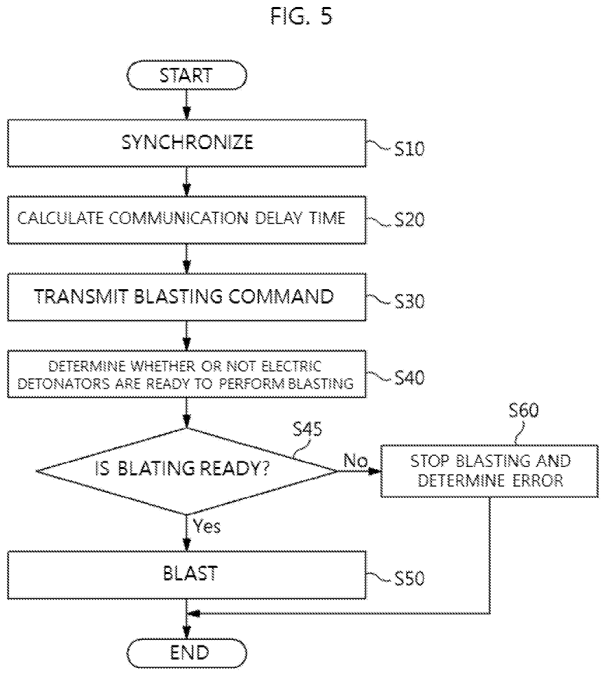

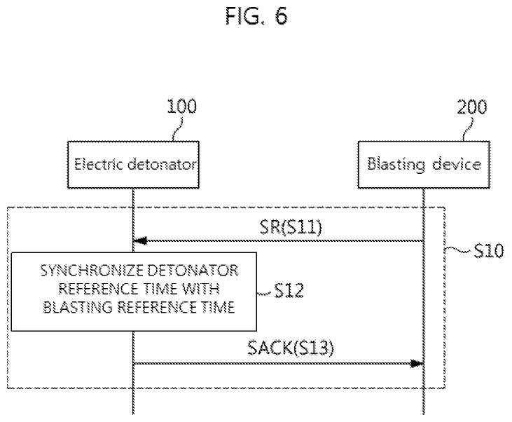

FIG. 5 is a flowchart illustrating a method of operating the wireless blasting system 10 according to an embodiment of the present invention.

The method of operating the wireless blasting system 10 will be described in detail with reference to FIGS. 1 to 5.

First, in S10, synchronization between the electric detonators 100 and the blasting device 200 may be performed. That is, the reference time of the detonator GPS part 130 of the respective electric detonators 100 may be synchronized with the reference time of the blasting GPS part 230 of the blasting device 200. For example, since the time system of the GPS clock may vary depending on the position (i.e. longitude), the reference time of the detonator GPS part 130 and the reference time of the blasting GPS part 230 located in different positions must be synchronized with each other, so that the same counting is applied to the set ignition initialization time. Details with regard thereto will be described with reference to FIG. 6.

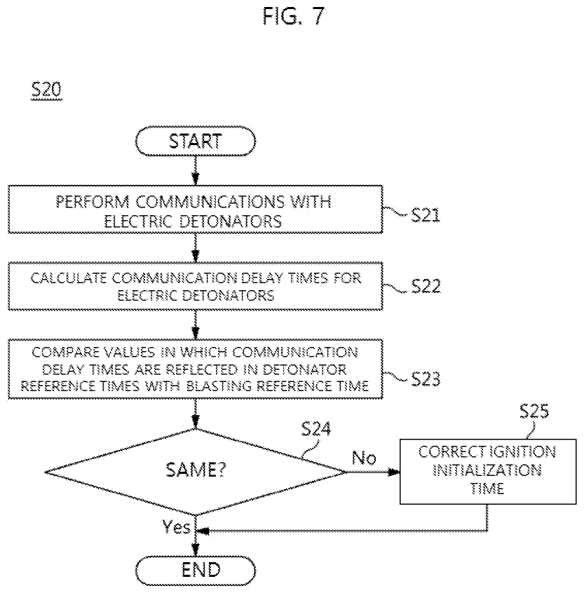

In S20, the blasting device 200 may calculate communication delay times of the electric detonators 100. That is, the blasting device 200 may perform communications with the electric detonators 100 and calculate the communication delay times of the electric detonators 100. Details with regard thereto will be described with reference to FIG. 7.

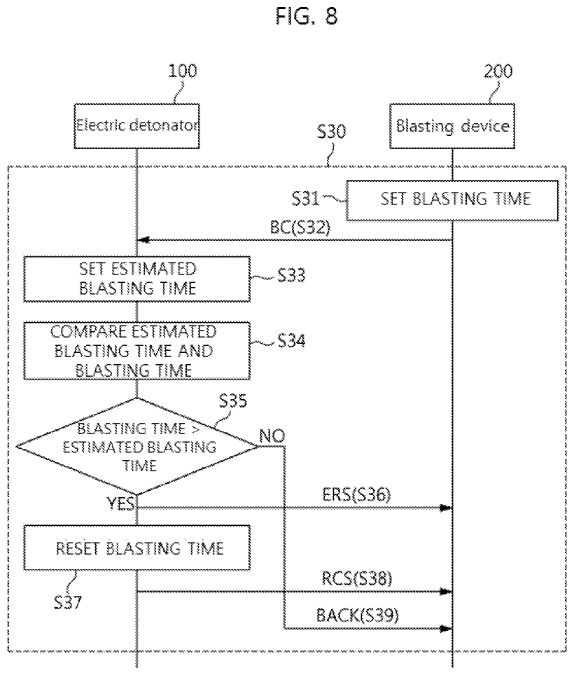

In S30, the blasting device 200 may transmit the blasting command to the electric detonators 100. That is, the blasting device 200 may transmit the blasting command including a blasting time to the electric detonators 100. Details with regard thereto will be described with reference to FIG. 8.

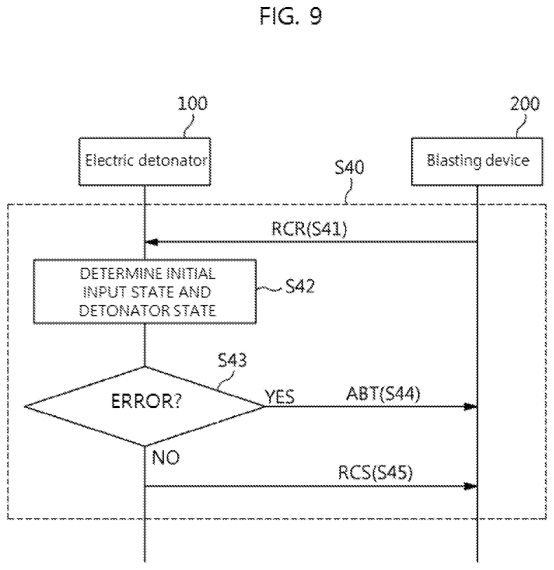

In S40, the blasting device 200 may determine whether or not the respective electric detonators 100 are ready to perform blasting. That is, each of the electric detonators 100 may determine an initialization input state of the ignition initialization time and a detonator state and, when there is an error, transmit an error signal to the blasting device 200. In addition, when there is no error, the electric detonator 100 may transmit a ready signal to the blasting device 200. In this case, the blasting device 200 may determine whether or not the respective electric detonators 100 are ready to perform blasting on the basis of the error signal and the ready signal. Details with regard thereto will be described with reference to FIG. 9.

When blasting is ready to be performed (YES in S45), the electric detonators 100 and the blasting device 200 may perform detonation by counting the ignition initialization times in which the communication delay times are reflected.

When blasting is not ready to be performed (NO in S45), the electric detonators 100 and the blasting device 200 may stop the detonation and determine an error.

FIG. 6 is a diagram illustrating the synchronization step S10 according to the embodiment of the present invention. The step S10 of synchronizing the respective electric detonators 100 and the blasting device 200 will be described with reference to FIGS. 1 to 6.

The synchronization step S10 may include: step S11 of transmitting, by the blasting device 200, a synchronization request SR to the respective electric detonators 100; step S12 of synchronizing, by the electric detonators 100, the detonator reference times with the blasting reference time; and step S13 of transmitting, by the respective electric detonators 100, a synchronization acknowledgement SACK to the blasting device 200.

In S11, the blasting device 200 may transmit synchronization request SR to the respective electric detonators 100. That is, the blasting device 200 may transmit the synchronization request SR including the blasting reference time of the blasting GPS part 230 to the respective electric detonators 100.

In S12, the respective electric detonators 100 may synchronize the detonator reference time of the detonator GPS part 130 with the blasting reference time of the blasting GPS part 230. For example, the respective electric detonators 100 may perform the synchronization by setting the detonator reference time of the detonator GPS part 130 to be the blasting reference time included in the synchronization request SR. For example, the blasting reference time may be the GPS absolute time of the blasting device 200, and the detonator reference time may be the GPS absolute time of the respective electric detonators 100.

In S13, the respective electric detonators 100 may transmit the synchronization acknowledgement SACK to the blasting device 200. That is, the electric detonator 100 may transmit the synchronization acknowledgement SACK, indicating that the synchronization is completed, to the blasting device 200, and the blasting device 200 may determine the completion of the synchronization upon receiving the synchronization acknowledgement SACK.

FIG. 7 is a flowchart illustrating the step S20 of calculating the communication delay time according to an embodiment of the present invention. Hereinafter, the step S20 of calculating, by the blasting device 200, the communication delay times of the electric detonators 100 will be described in detail with reference to FIGS. 1 to 7.

The step S20 of calculating, by the blasting device 200, the communication delay times of the electric detonators 100 may include: step S21 of performing, by the blasting device 200, communications with the electric detonators 100; step S22 of calculating, by the blasting device 200, the communication delay times of the electric detonators 100; step S23 of comparing values in which the communication delay times corresponding to the detonator reference times are reflected with the blasting reference time; and step S25 of, when a value among the values in which the communication delay times corresponding to the detonator reference times are reflected differs from the blasting reference time, correcting a corresponding ignition initialization time.

First, in S21, the blasting device 200 may perform communications with the electric detonators 100. That is, the blasting device 200 may transmit a signal (e.g. a dummy signal) to the respective electric detonators 100 via the wireless network or receive a signal from the respective electric detonators 100. In some embodiments, the blasting device 200 may periodically or aperiodically perform communications with the electric detonators 100. Accordingly, the blasting device 200 may determine the detonator reference times of the electric detonators 100.

In S22, the blasting device 200 may calculate the communication delay time of the respective electric detonators 100. For example, a communication delay may occur depending on the position or environment of the respective electric detonators 100. The blasting device 200 may measure a time value (or a length of time) from a moment at which a signal is transmitted to a moment at which the signal is received and calculate the communication delay time of the respective electric detonators 100 on the basis of the measured time value.

In S23, the blasting device 200 may compare the values in which the communication delay times corresponding to the detonator reference times are reflected with the blasting reference time. For example, the blasting device 200 may calculate the values in which the communication delay times corresponding to the detonator reference times of the electric detonators 100 are reflected and compare the calculated values with the blasting reference time of the blasting device 200.

When a value among the values in which the communication delay times corresponding to the detonator reference times are reflected is different from the blasting reference time (NO in S24), the blasting device 200 may correct the ignition initialization time corresponding to the detonator reference time of the corresponding electric detonator in S25. For example, the blasting device 200 may perform a correction by subtracting the corresponding communication delay time from the corresponding ignition initialization time.

That is, the wireless blasting system 10 according to the present invention may correct the ignition initialization time of an electric detonator, in which a communication delay occurs, by reflecting the communication delay time, so that blasting can be performed more accurately.

FIG. 8 is a flowchart illustrating the step S30 of transmitting the blasting command according to an embodiment of the present invention. Hereinafter, the step S30 of transmitting, by the blasting device 200, the blasting command to the respective electric detonators 100 will be described in detail with reference to FIGS. 1 to 8.

The step S30 of transmitting, by the blasting device 200, the blasting command BC to the respective electric detonators 100 may include: step S31 of setting, by the blasting device 200, the blasting time; step S32 of transmitting, by the blasting device 200, the blasting command to the electric detonator 100; step S33 of setting, by the electric detonator 100, an estimated blasting time; step S34 of comparing, by the electric detonator 100, the estimated blasting time with the blasting time; step S36 of, when the blasting times is greater than the estimated blasting time (YES in S35), transmitting, by the electric detonator 100, an error signal ERS to the blasting device 200; step S37 of resetting the electric detonator 100 with the blasting time; step S38 of transmitting, by the electric detonator 100, a reset complete signal RCS to the blasting device 200; and step S39 of, when the blasting time is not greater than the estimated blasting time (NO in S35), transmitting, by the electric detonator 100, a blasting acknowledgement BACK to the blasting device 200.

First, in S31, the blasting device 200 may set the blasting time. That is, the blasting device 200 may set the blasting time on the basis of a maximum communication delay time and a state inspection time. Here, the maximum communication delay time may mean a maximum value among the communication delay times for the electric detonators 100. The state inspection time may be a time consumed to inspect the states of the electric detonators 100 before the blasting. In some embodiments, the state inspection time may be a predetermined length of time. For example, the blasting device 200 may set a sum of the maximum communication delay time and the state inspection time to be the blasting time. However, the present invention is not limited thereto, and in some embodiments, the blasting device 200 may set a sum of the communication delay time, the state inspection time, and a preparation time (e.g. a predetermined value) to be the blasting time.

In S32, the blasting device 200 may transmit the blasting command BC to the respective electric detonators 100. That is, the blasting device 200 may transmit the blasting command BC including the blasting time to the electric detonators 100.

In S33, the electric detonator 100 may set the estimated blasting time. That is, the electric detonator 100 may set the estimated blasting time on the basis of the communication delay time. For example, the electric detonator 100 may set the estimated blasting time by adding a detonator-specific characteristic value to the corresponding communication delay time. In some embodiments, the detonator-specific characteristic value may be set to be a constant.

In S34, the respective electric detonator 100 may compare the blasting time with the estimated blasting time thereof. That is, the electric detonator 100 may compare the blasting time with the estimated blasting time thereof in order to prevent the electric detonator 100 from igniting before the blasting time set by the blasting device 200.

When the blasting time is greater than the estimated blasting time (YES in S35), the electric detonator 100 may transmit the error signal ERS to the blasting device 200 in S36.

Afterwards, in S37, the electric detonator 100 may be reset by the blasting time received from the blasting device 200. That is, the electric detonator 100 may be reset by determining that the estimated blasting time calculated thereby is inappropriate and correcting the estimated blasting time to be the blasting time received from the blasting device 200.

In S38, the electric detonator 100 may transmit the reset complete signal RCS to the blasting device 200. When the reset complete signal RCS is received, the blasting device 200 may determine that the resetting of the blasting time of the electric detonator 100 is completed.

When the blasting time is not greater than the estimated blasting time (NO in S35), the electric detonator 100 may transmit the blasting acknowledgement BACK to the blasting device 200. When the blasting acknowledgement BACK is received, the blasting device 200 may determine that the electric detonator 100 has received the blasting command.

FIG. 9 is a flowchart illustrating the step S40 of determining whether or not blasting is ready to be performed according to an embodiment of the present invention. Hereinafter, the step S40 of determining, by the blasting device 200, whether or not the respective electric detonators 100 are ready to perform blasting will be described in detail with reference to FIGS. 1 to 9.

The step S40 of determining whether or not blasting is ready to be performed may include step S41 of transmitting, by the blasting device 200, a ready confirmation request RCR to the respective electric detonators 100; step S42 of determining, by the electric detonator 100, an initial input state and a detonator state; step S44 of transmitting, by the electric detonator 100, a stop signal ABT to the blasting device 200; and step S45 of transmitting, by the electric detonator 100, a ready signal RCS to the blasting device 200.

First, in S41, the blasting device 200 may transmit the ready confirmation request RCR to the electric detonators 100. For example, the blasting device 200 may transmit the ready confirmation request RCR to the electric detonators 100 in order to determine that the electric detonators 100 are in normal states.

In S42, the respective electric detonators 100 may determine the initial input state and the detonator state. For example, the electric detonator 100 may determine whether or not the detonator initialization time included in the blasting command BC is normally input. In addition, the electric detonator 100 may determine the detonator state.

When there is an error (YES in S43), the electric detonator 100 may transmit the stop signal ABT to the blasting device 200. For example, the blasting device 200 may determine that the error has occurred in the electric detonator 100 in response to the stop signal ABT.

When there is no error (NO in S43), the electric detonator 100 may transmit the ready signal RCS to the blasting device 200 in S45. For example, when the ready signal RCS is received, the blasting device 200 may determine that the electric detonator 100 is ready to perform blasting.

As set forth above, the wireless blasting system and the operating method thereof according to embodiments of the present invention can accurately perform blasting in consideration of communication delay times in the case of long-range wireless communications.

In addition, the wireless blasting system and the operating method thereof according to embodiments of the present invention can reduce working times and working costs.

In addition, the wireless blasting system and the operating method thereof according to embodiments of the present invention are applicable to massive mine blasting.

Although the exemplary embodiments of the present invention have been described for illustrative purposes, those skilled in the art or those having ordinary knowledge in the art will appreciate that various modifications, additions and substitutions are possible without departing from the scope and spirit of the present invention as disclosed in the accompanying claims.

Therefore, the technical scope of the present invention is not limited to the exemplary embodiments described herein, but should be determined on the basis of the claims.

1. A method of operating a wireless blasting system in which a blasting device and electric detonators perform communications via a wireless network, the method comprising:
synchronizing detonator reference times of the electric detonators with a blasting reference time of the blasting device;
calculating communication delay times of the electric detonators;
transmitting, by the blasting device, a blasting command including a blasting time to the electric detonators;
determining whether or not the electric detonators are ready to perform blasting by determining initial input states and detonator states of the electric detonators; and
when the electric detonators are ready, performing, by the electric detonators, the blasting by counting ignition initialization times thereof in which the communication delay times are reflected.

2. The method according to claim 1, wherein the synchronization includes:
transmitting, by the blasting device, a synchronization request including the blasting reference time to the electric detonators;
synchronizing, by the electric detonators, the detonator reference times with the blasting reference time by setting the detonator reference times to be the blasting reference time; and
transmitting, by the electric detonators, synchronization complete signals to the blasting device.

3. The method according to claim 2, wherein the calculating of the communication delay times includes:
performing, by the electric detonators and the blasting device, communications via the wireless network;
calculating, by the blasting device, the communication delay times of the electric detonators;
comparing, by the blasting device, values in which the communication delay times corresponding to the detonator reference times are reflected with the blasting reference time; and
when a value among the values in which the communication delay times corresponding to the detonator reference times are reflected is equal to the blasting reference time, correcting a corresponding ignition initialization time among the ignition initialization times.

4. The method according to claim 3, wherein the transmitting of the blasting command includes:
setting, by the blasting device, the blasting time on a basis of a maximum communication delay time and a state inspection time of the electric detonators; and
transmitting, by the blasting device, the blasting command including the blasting time to the electric detonators.

5. The method according to claim 4, wherein the blasting device sets a sum of the maximum communication delay time and the state inspection time to be the blasting time.

6. The method according to claim 4, wherein the transmitting of the blasting command includes:
calculating, by the electric detonators, estimated blasting times on a basis of the communication delay times;
comparing, by the electric detonators, the estimated blasting times with the blasting time;
when the blasting time is greater than an estimated blasting time among the estimated blasting times, transmitting, by a corresponding electric detonator among the electric detonators, an error signal to the blasting device; and
resetting the electric detonator with the received blasting time and transmitting, by the electric detonator, a reset complete signal to the blasting device.

7. The method according to claim 6, further comprising, when the blasting time is not greater than an estimated blasting time among the estimated blasting times, transmitting, by a corresponding electric detonator among the electric detonators, a blasting acknowledgement to the blasting device.

8. The method according to claim 5, wherein the determining of whether or not the electric detonators are ready includes:
transmitting, by the blasting device, a ready confirmation request to the electric detonators;
determining, by the electric detonators, initial input states and detonator states in response to the ready confirmation request;
when there is an error, transmitting, by an electric detonator among the electric detonators, a stop signal to the blasting device; and
when there is no error, transmitting, by an electric detonator among the electric detonators, a preparation complete signal to the blasting device.

9. The method according to claim 1, wherein each of the blasting device and the electric detonators includes a global positioning system device counting an absolute time.

10. The method according to claim 1, wherein the blasting device is disposed in a safe area, the electric detonators are disposed in a blasting area spaced apart from the safe area by a safe distance,
the safe distance is a value predetermined by a blasting operator, and
when the blasting device is located within the safe distance, the blasting is stopped.

11. A blasting system comprising:
electric detonators disposed in blasting holes of a blasting target to detonate explosives; and
a blasting device performing communications with the electric detonators via a wireless network,
wherein the blasting device synchronizes the detonator reference times of the electric detonators with the blasting reference time of the blasting device and calculates communication delay times of the electric detonators, and
each of the blasting device and the electric detonators includes a global positioning system device.

12. The blasting system according to claim 11, wherein the blasting device is disposed in a safe area, the electric detonators are disposed in a blasting area spaced apart from the safe area by a safe distance,
the safe distance is a value predetermined by a blasting operator, and
when the blasting device is located within the safe distance, the blasting is stopped.
